(19) United States
(12) Patent Application Publication
(10) Pub. No.: US 2002/0196232 A1
(43) Pub. Date: Dec. 26, 2002

(54) Input device with two elastic fulcrums for six degrees of freedom data input

(76) Inventor: Chih-Feng Chen, Kaohsiung (TW)

Correspondence Address: Mathews, Collins, Shepherd & Gould, P.A., Suite 306, 100 Thanet Circle, Princeton, NJ, 08540-3674, US

(21) Appl. No.: 09/887,421

(22) Filed: Jun. 22, 2001

(51) Int. Cl. G09G 5/08

(52) U.S. Cl. 345/161

(57) ABSTRACT

An input device for providing positional and altitude information to a computer is disclosed. The computer input device includes a movable hand-held shaft, two suspending elements, plural position sensors and a microprocessor. Data for six degrees of freedom can be calculated by a defined algrorithm and mapping method. Data can be sent via an input/output interface to move a cursor, a viewpoint, or a position and orientation of a virtual object on a display.

### FIELD OF THE INVENTION

The present invention relates to an input device for a computer or an input driven device, and more particularly to an input device for a computer or an input driven device that is capable of providing data input of up to six degrees of freedom (6DoF). The input device of the present application also allows a user to control movement of a virtual object in any three dimensional environment.

### BACKGROUND OF THE INVENTION

Computer systems are used extensively in many different industries to implement many applications, such as word processing, data management, simulations, games, and other tasks. A computer system typically displays a visual object to a user on a display or other visual output device. User can interact with the displayed object to perform functions on the computer, play a game, experience a simulation or virtual reality environment, use a computer aided design system, or otherwise influence events or images depicted on the screen.

With the rapid advancement of virtual reality environments which allow fully three-dimensional simulation of a virtual world, there is an increasing need for input devices which allow intuitive control of dimensions beyond the two-dimensional controls currently offered by a mouse, trackball or joystick. It is well known that some input devices currently provide three-dimensional inputs of up to six degrees of freedom (6DoF). That is to say, 6DoF devices enable translational control along the conventional three axes (i.e. X-axis, Y-axis, and Z-axis) and rotational control about each of the three axes, commonly referred to as pitch, yaw and roll. These devices currently utilize magnetic, acoustic, infrared and mechanical method to achieve 6DoF tracking. 6DoF controllers employing mechanical method are typically utilized in the operation of heavy equipment. Such controllers present a non-intuitive user interface and require significant mental agility and experience to operation.

One type of 6DoF input control device is found in U.S. Pat. No. 6,047,610 (Stocco et al.) which provides a robotic manipulator consisting of two five-bar linkages set on rotatable base linkages. The output points of the five-bar linkages are attached to a rigid payload platform by universal joints, respectively. Each linkage on its rotatable base can position its output point in three degrees of freedom, but since the two five-bar linkage are tied together at the platform, five degree of freedom motion of the platform results three degrees of freedom in translation, and two of rotation. A seventh motor, mounted for example on one of the five-bar linkages, provides power to rotate the platform about the axis defined by the two universal joints. The rotational torque is coupled through one of the universal joints. However, the structure of such a 6DoF input control device is complex and needs to employ complex geometric calculations. Moreover, such an input control device can't provide a returning force for returning the input control device to an initial position.

U.S. Pat. No. 5,898,421 discloses a vertical gyroscope adapted for use as a pointing device for controlling the position of a cursor on the display of a computer. A motor at the core of the gyroscope is suspended by two pairs of orthogonal gimbals from a hand-held controller device and nominally oriented with its spin axis vertical by a pendulous device. Electro-optical shaft angle encoders sense the orientation of a hand-held controller device as it is manipulated by a user and the resulting electrical output is converted into a format usable by a computer to control the movement of a cursor on the screen of the computer display. For additional ease of use, the bottom of the controller is rounded so that the controller can be pointing while sifting on a surface. A third input is provided by providing a horizontal gyroscope within the pointing device. The third rotational signal can be used to either rotate a displayed object or to display or simulate a third dimension. However, such a pointing device can only provide 3DoF data input and has a complex structure so that it isn't suitable for virtual reality environments.

U.S. Pat. No. 5,889,505 discloses a vision-based controller for providing translational and rotational control signals to a computer or other input driven device. The controller includes a tracked object, positioned in space and having at least a first reference point and a second reference point. The tracked object is capable of performing three dimensional rotational and translational movement. At least one imaging device, positioned at a distance from the tracked object, generates an image of the tracked object, at plural succeeding times. A processor unit receives the image, comprised of pixel values, from the imaging device, identifies pixels corresponding to a current center of the tracked object, the first reference point and the second reference point, determines a current dimension (i.e., size or radius) of the tracked object, calculates a translational and rotational displacement of the tracked object based on the above information, and generates control signals in accordance with the transitional and rotational displacement. However, such a vision-based controller needs to employ complex software calculation.

In summary, these types of input devices have the following defects:

1. None of these input devices can provide a returning force for returning the input device to an initial position.

2. Most of these input devices need to employ complex geometric calculations.

3. The structures of these input devices are complex.

4. Low resolution and sensitivity.

Accordingly, it is desirable for the applicant to provide an input device having high resolution and simple structure. Further, it is also desirable for the applicant to provide an input device without employing complex geometric calculation and capable of providing data input of up to 6DoF.

### SUMMARY OF THE INVENTION

It is therefore an object of the present invention to provide an input device capable of providing data input of up to 6DoF.

It is further an object of the present invention to provide a 6DoF input device produced at lower cost.

It is still an object of the present invention to provide a 6DoF input device without employing complex geometric calculation.

It is additional an object of the present invention to provide an input device having high resolution and simple structure comparing with any one of the prior arts.

According to the present invention, an input device for providing positional and attitude input data to one of computer and an input driven device is provided. The input device of the present invention includes a movable hand-held shaft having two fulcrums thereon, two suspending elements respectively connected to two movable fulcrums of the movable hand-held shaft for providing a returning force to the movable hand-held shaft so as to return the movable hand-held shaft to an initial position, two first position sensors respectively connected with the two suspending elements for detecting the translational displacement along X and Y axes of the movable hand-held shaft, a second position sensor disposed in the movable hand-held shaft for detecting the translational and rotational displacement along Z axis of the movable hand-held shaft, and a microprocessor for processing the translational and rotational displacement to obtain the positional and attitude input data to be sent to one of the computer and the input driven device.

In accordance with one aspect of the present invention, the microprocessor can process the translational and rotational displacement to obtain the positional and attitude input data via defined algorithm.

In accordance with another aspect of the present invention, the microprocessor can process the translational and rotational displacement to obtain the positional and attitude input data via mapping method.

Preferably, the positional and attitude input data is six degrees of freedom input data comprising 3-dimensional positional information and attitude information including pitch, yaw, and roll.

In accordance with one aspect of the present invention, the movable hand-held shaft further comprises at least one button for providing at least one control signal to one of the computer and the input driven device.

In accordance with another aspect of the present invention, each of the first position sensors is a planar position sensor including a first elastic belt, a first set of fixed pulley for guiding the first elastic belt, a first optical grating sensor having a first optical grating plate driven by the first elastic belt in response to the movement of the movable hand-held shaft for detecting the translational displacement of the movable hand-held shaft, a second elastic belt, a second set of fixed pulley for guiding the second elastic belt, and a second optical grating sensor having a second optical grating plate driven by the second elastic belt in response to the movement of the movable hand-held shaft for detecting the translational displacement of the movable hand-held shaft. Preferably, the first and second elastic belts are connected to one suspending end of the movable hand-held shaft at an intersection thereof.

In accordance with another aspect of the present invention, the second position sensor includes a third optical grating sensor having a third optical grating plate driven by a first gear of the movable hand-held shaft for detecting the translational displacement along Z axis of the movable hand-held shaft, and a fourth optical grating sensor having a fourth optical grating plate driven by a second gear of the movable hand-held shaft for detecting the rotational displacement about Z-axis of the movable hand-held shaft.

Preferably, the suspending element is an elastic element capable of providing the returning force to the movable hand-held shaft. More preferably, the elastic element is one selected from a group consisting of spring, rubber pad, and elastic belt.

In accordance with another aspect of the present invention, the input data further includes a control device for controlling the input device to turn off some of the position sensors, thereby allowing the input device to provide two degrees of freedom input data.

In accordance with another aspect of the present invention, the movable hand-held shaft further comprises a main shaft covered by two separated cases, a first gear mounted on the middle portion of the main shaft, two first springs disposed around the main shaft at two sides of the first gear for providing a returning force along Z-axis to return the movable hand-held shaft to the initial position, a second gear mounted on the lower portion of the main shaft, a first projection disposed on one end of the main shaft, and a second spring disposed around the main shaft and adjacent to the first projection. The second spring and the first projection can cooperate with a second projection of the cases to provide a rotational returning force about Z-axis, thereby returning the movable hand-held shaft to the initial position.

It is more an object of the present invention to provide an input device for providing positional and attitude input data to effect translational and rotational movements of a displayed object on a display. The input device of the present invention includes a movable hand-held shaft having two movable fulcrums thereon, two suspending elements respectively connected to two fulcrums of the movable hand-held shaft for providing a returning force to the movable hand-held shaft so as to return the movable hand-held shaft to an initial position, two first position sensors respectively connected with the two suspending elements for detecting the translational displacement along X and Y axes of the movable hand-held shaft, a second position sensor disposed in the movable hand-held shaft for detecting the translational and rotational displacement along Z axis of the movable hand-held shaft, and a microprocessor for processing the translational and rotational displacement to obtain the positional and attitude input data to effect translational and rotational movements of the displayed object on the display.

Another object of the present invention is to provide a planar position sensor for detecting a translational movement of an object. The planar position sensor comprises a first elastic belt, a first set of fixed pulley for guiding the first elastic belt, a first optical grating sensor having a first optical grating plate driven by the first elastic belt in response to the movement of the object for detecting the translational displacement of the object, a second elastic belt, a second set of fixed pulley for guiding the second elastic belt, and a second optical grating sensor having a second optical grating plate driven by the second elastic belt in response to the movement of the object for detecting the translational displacement of the object, wherein the first and the second elastic belts are connected to one end of the object at an intersection thereof.

The present invention may be best understood through the following description with reference to the accompanying drawings, in which:

### BRIEF DESCRIPTION OF THE DRAWINGS

FIG. 1 is an expanded perspective view showing an input device according to the present invention;

FIG. 2 is an expanded perspective view showing a movable hand-held shaft of the input device according to the present invention;

FIG. 3 is a schematic view showing the assembly of the input device according to the present invention;

FIG. 4 is a schematic view showing one of the planar position sensors according to the present invention;

FIG. 5 is a cross-sectional view showing the assembly of the movable hand-held shaft according to the present invention; and

FIGS. 6(a)-(e) are diagrams showing the translational and rotational displacements of the movable hand-held shaft according to the defined algorithm of the present invention.

### DETAILED DESCRIPTION OF THE PREFERRED EMBODIMENTS

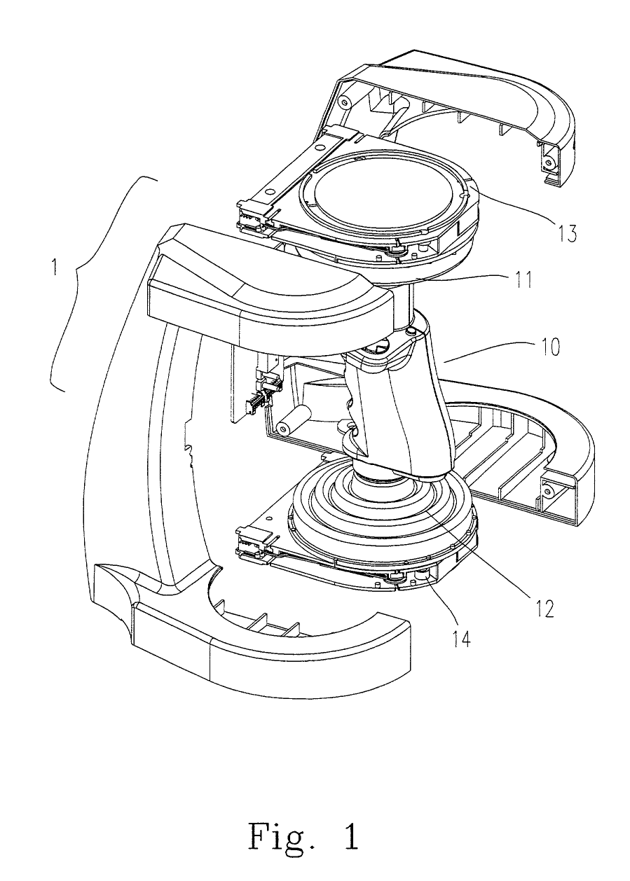

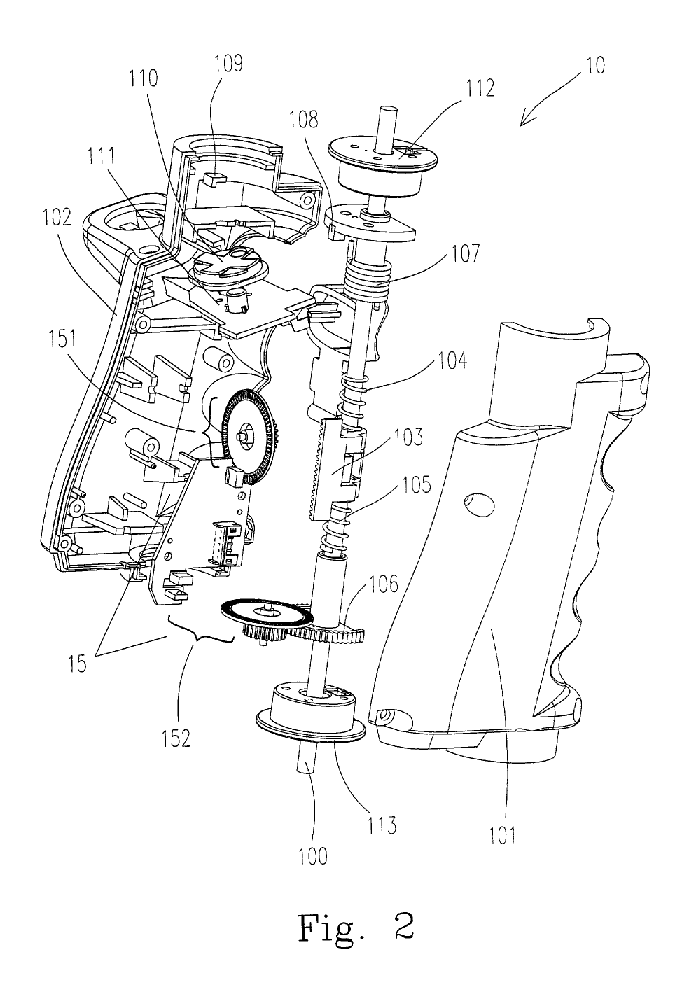

FIG. 1 is an expanded perspective view showing an input device according to the present invention. The input device 1 of the present invention is capable of providing positional and attitude input data of up to six degrees of freedom (6DoF) to a computer (not shown) and allows a user to control movement of a virtual object in any three dimensional environment. The input device 1 of the present invention includes a movable hand-held shaft 10, two suspending elements (11 and 12), a plurality of position sensors (13, 14 and 15) and a microprocessor (not shown). Please refer to FIG. 2, which is an expanded perspective view showing the movable hand-held shaft 10 of the input device 1 according to the present invention. The movable hand-held shaft 10 is movable along X-axis, Y-axis and Z-axis and rotatable about X-axis, Y-axis and Z-axis and allows a user to control movement of a virtual object shown on a display screen (not shown). The movable hand-held shaft 10 includes a main shaft 100 covered by two separated cases (101 and 102), a first gear 103 mounted on the middle portion of the main shaft 100, two springs (104 and 105) disposed around the main shaft 100 at two sides of the first gear 103, and a second gear 106 mounted on the lower portion of the main shaft 100. These springs (104 and 105) can provide a returning force along Z-axis to return the movable hand-held shaft 10 to an initial position when the movable hand-held 10 is forced to move along Z-axis. In addition, the movable hand-held shaft 10 further includes a spring 107 disposed around and adjacent to one end of the main shaft 100 and a projection 108 disposed adjacent to the spring 107. The spring 107 and projection 108 can cooperate with a projection 109 of the case 102 to provide a rotational returning force about Z-axis, thereby returning the movable hand-held shaft 10 to the initial position when the movable hand-held shaft 10 is forced to rotate about Z-axis. In addition, the movable hand-held shaft 10 can be designed to have plural buttons (110 and 111) thereon for allowing the user to perform other functions of controlling the displayed object on the display.

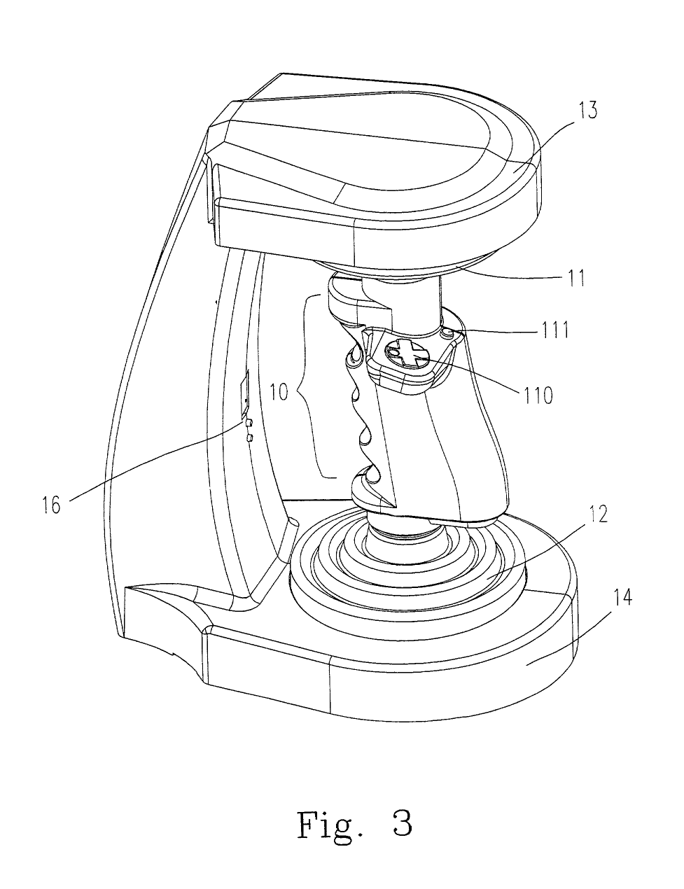

Please refer to FIG. 3, which is a schematic view showing the assembly of the input device according to the present invention. As shown in FIG. 3, two suspending elements (11 and 12) are respectively connected to two movable fulcrums (112 and 113) of the movable hand-held shaft 10 for providing a planar returning force to the movable hand-held shaft 10, thereby returning the movable hand-held shaft 10 to an initial position. Preferably, the suspending elements (11 and 12) are elastic elements capable of providing planar returning force to the movable hand-held shaft 10. More preferably, the elastic element is spring, rubber pad, or elastic belt.

Please refer to FIGS. 1 and 2 again. As shown in FIGS. 1 and 2, plural position sensors (13, 14 and 15) are provided for detecting the translational and rotational displacement of the movable hand-held shaft 10. These position sensors (13, 14 and 15) includes two first position sensors (13 and 14) and a second position sensor 15. The first position sensors (13 and 14) are planar position sensors and respectively connected with two suspending elements (11 and 12) for detecting translational displacement along X and Y axes of the movable hand-held shaft 10. The second position sensor 15 is disposed in the cases (102 and 103) and adjacent to the main shaft 100 for detecting the translational and rotational displacement along Z-axis of the movable hand-held shaft 10.

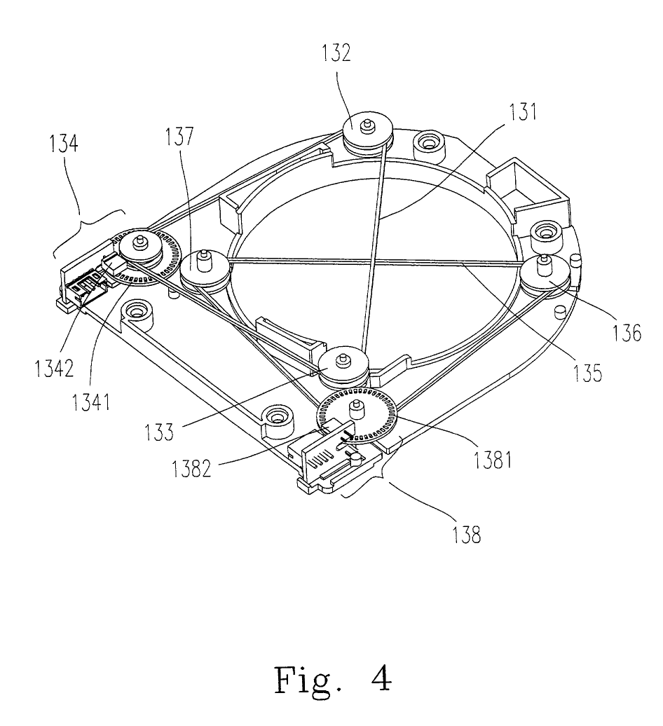

Please refer to FIG. 4, which is a schematic view showing one of the planar position sensors according to the present invention. As shown in FIG. 4, the planar position sensor (13 or 14) of the present invention includes a first elastic belt 131, a first set of fixed pulley (132 and 133), a first optical grating sensor 134, a second elastic belt 135, a second set of fixed pulley (136 and 137), and a second optical grating sensor (138). The first set of fixed pulley (132 and 133) is used for guiding the first elastic belt 131, and the second set of fixed pulley (136 and 137) is used for guiding the second belt 135. The first elastic belt 131 and the second elastic belt 135 are connected to one suspending end (not shown) of the movable hand-held shaft 10 at an intersection thereof. The first optical grating sensor 134 has a first optical grating plate 1341 driven by the first elastic belt 131 in response to the movement of the movable hand-held shaft 10, and the second optical grating sensor 138 has a second optical grating plate 1381 driven by the second elastic belt 1381 in response to the movement of the movable hand-held shaft 10. When the movable hand-held shaft 10 is forced to move by the user, the suspending end of the movable hand-held shaft 10 can promote the first elastic belt 131 and the second elastic belt 135 to drive the first optical grating plate 1341 and the second optical grating plate 1381. Each of the first optical grating plate 1341 and the second optical grating plate 1381 has plural spaced-apart optical grates thereon. Two optical sensors 1342 and 1382 which are respectively disposed adjacent to the first optical grating plate 1341 and the second grating plate 1381 can be used to detect the rotational displacement of the first optical grating plate 1341 and the second optical grating plate 1381. Therefore, the first optical grating sensor 134 and the second optical grating sensor 138 can be used for detecting the translational displacement of the movable hand-held shaft 10 via coordinate conversion.

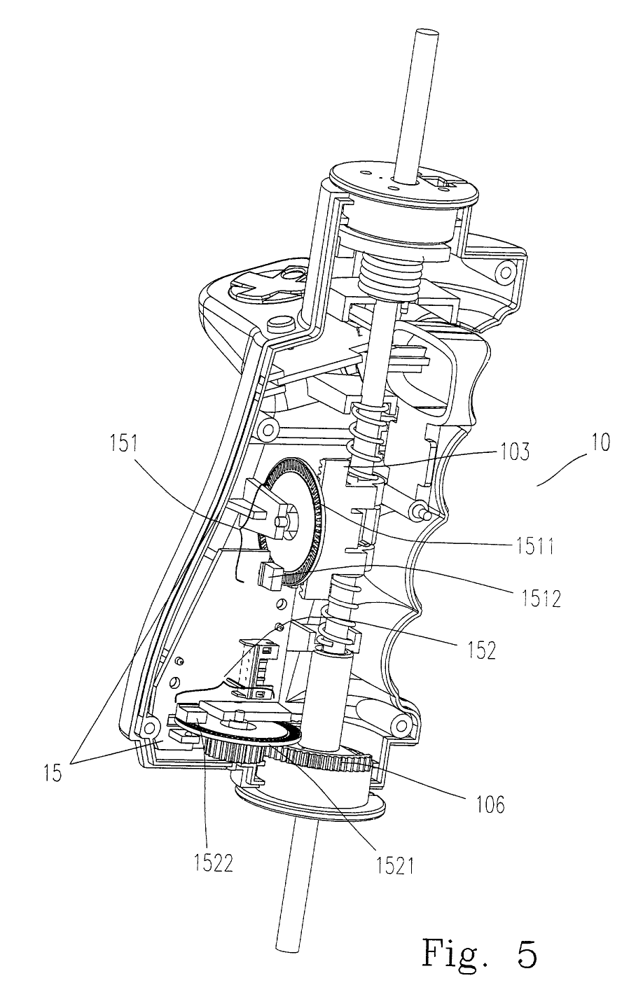

Please refer to FIG. 5, which is a cross-sectional view showing the movable hand-held shaft according to the present invention. The second position sensor 15 includes a third optical grating sensor 151 for detecting the translational displacement along Z-axis of the movable hand-held shaft 10, and a fourth optical grating sensor 152 for detecting the rotational displacement about Z-axis of the movable hand-held shaft 10. As shown in FIG. 5, the third optical grating sensor 151 has a third optical grating plate 1511 capable of being driven by the first gear 103 of the main shaft 100, and an optical sensor 1512 disposed adjacent to the third optical grating plate 1511 for detecting the rotational displacement of the third optical grating plate 1511. When the movable hand-held shaft 10 is moved along Z-axis, the first gear 103 of main shaft 100 can drive the third optical grating plate 1511 to rotate and the optical sensor 1512 can detect the rotational displacement of the third optical grating plate 1511. Therefore, the translational displacement along Z-axis of the movable hand-held shaft 10 can be determined via the third optical grating sensor 151.

Please refer to FIG. 5 again. The fourth optical grating sensor 152 has a fourth optical grating plate 1521 capable of being driven by the second gear 106 of the movable hand-held shaft 10, and an optical sensor 1522 disposed adjacent to the fourth optical grating plate 1521 for detecting the rotational displacement of the fourth optical grating plate 1521. When the movable hand-held shaft 10 is rotated about Z-axis, the second gear 106 of the movable hand-held shaft 10 can drive the fourth optical grating plate 1521 to rotate and the optical sensor 1522 can detect the rotational displacement of the fourth optical grating plate 1521. Therefore, the rotational displacement about Z-axis of the movable hand-held shaft 10 can be determined via the fourth optical grating sensor 152.

Certainly, the position sensors of the present invention are not limited to the optical grating sensors described above. Example of some of position sensors can be found upon reference to U.S. Pat. Nos. 6,061,004; 4,550,250; and 4,654,648, the disclosures of which are hereby incorporated by reference.

The data detected by the position sensors (13, 14 and 15) can be transmitted to a microprocessor (not shown). The microprocessor can convert the data transmitted from those position sensors (13, 14 and 15) into the positional and attitude input data of 6DoF to the computer, and output other controlling signals generated from the buttons of the input device 1 to the computer. Certainly, the communication between the input device 1 and the computer (not shown) can be performed via any form of computer interface such as keyboard, mouse, joystick, PS/2, RS-232, USB and IEEE 1394 and cordless transmitter.

6DoF data input can be calculated by a defined algorithm and mapping method as described below:

Please refer to 6(a). The translational displacement along X-axis can be defined as follow:

1/2X₁+1/2X₂=X (1)

Where X₁ is translational displacement along X-axis of the movable hand-held shaft detected by the planar position sensor 13, X₂ is translational displacement along X-axis of the movable hand-held shaft detected by the planar position sensor 14, and X is translational displacement along X-axis of the movable hand-held shaft according to the defined algorithm of the present invention.

Please refer to 6(b). The translational displacement along Y-axis can be defined as follow:

1/2Y₁+1/2Y₂=Y (2)

Where Y₁, is translational displacement along Y-axis of the movable hand-held shaft detected by the planar position sensor 13, Y₂ is translational displacement along Y-axis of the movable hand-held shaft detected by the planar position sensor 14, and Y is translational displacement along Y-axis of the movable hand-held shaft according to the defined algorithm of the present invention.

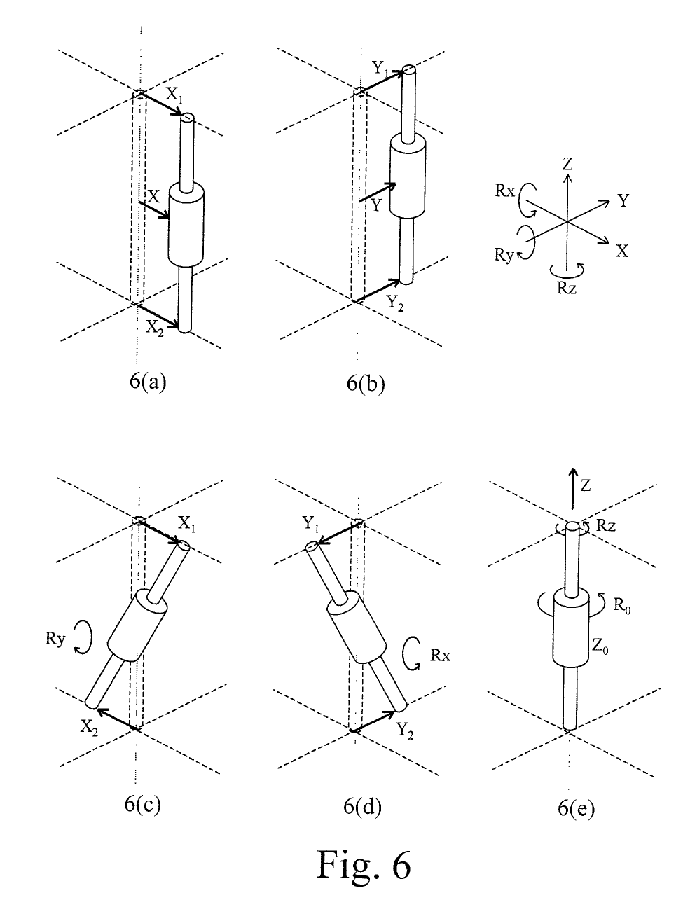

Please refer to FIG. 6(c). The rotational displacement about Y-axis can be defined as follow:

1/2X₁−1/2X₂=Ry (3)

Where X₁ is translational displacement along X-axis of the movable hand-held shaft detected by the planar position sensor 13, X₂ is translational displacement along X-axis of the movable hand-held shaft detected by the planar position sensor 14, and Ry is rotational displacement about Y-axis of the movable hand-held shaft according to the defined algorithm of the present invention.

Please refer to FIG. 6(d). The rotational displacement about X-axis can be defined as follow:

1/2Y₁−1/2Y₂=Rx (4)

Where Y₁ is translational displacement along Y-axis of the movable hand-held shaft detected by the planar position sensor 13, Y₂ is translational displacement along Y-axis of the movable hand-held shaft detected by the planar position sensor 14, and Rx is rotational displacement about X-axis of the movable hand-held shaft according to the defined algorithm of the present invention.

Please refer to FIG. 6(e). The translational displacement along Z-axis can be defined as follow:

3Z₀=Z (5)

Where Z₀ is translational displacement along Z-axis of the movable hand-held shaft detected by the second position sensor 15, and Z is the translational displacement along Z-axis of the movable hand-held shaft according to the defined algorithm of the present invention.

The rotational displacement about Z-axis can be defined as follow:

2R₀=Rz (6)

Where R₀ is rotational displacement about Z-axis of the movable hand-held shaft detected by the second position sensor 15, and Rz is rotational displacement about Z-axis of the movable hand-held shaft according to the defined algorithm of the present invention.

The data detected by these position sensors (13, 14 and 15) can be transferred to the microprocessor and converted to positional and altitude information of up to six degrees of freedom to the computer via the microprocessor according to the defined algorithm of the present invention. Certainly, 6DoF data input can also be calculated by employing other defined algorithm.

Such an input device can also employ a mapping table or multiply the measured value with a specific coefficient to modify the measured value at large angle or enlarge the measured value, thereby increasing the sensitivity of the input device. The method for multiplying a specific coefficient to the measured value is described as follow:

Multiply a specific coefficient to Rx (i.e. rotational displacement about X-axis) to allow the value of Rx to be located between 1 and −1. Then, take an inverse function of sine Rx to obtain a corresponding angle to be outputted to the computer.

In addition, a mapping table of relative displacement against angle can also be employed to determine the corresponding angle via mapping method.

Thereafter, microprocessor transmits the input data of up to six degrees of freedom to the computer, thereby effecting translational and rotational movements of a displayed object on a display. The input data of six degrees of freedom can relate to either strict translational and rotational displacement or velocity data, depending on the application, i.e. a computer game, heavy equipment, computer graphics, . . . etc. It should be noted that the microprocessor can be configured to allow elimination of non-required degrees of freedom (i.e., some applications may not need translational information). Such an arrangement can be performed by employing a control button 16 (as shown in FIG. 3) on the input device. The control button 16 can be used to control the input device to turn off some of the position sensors or control the microprocessor, thereby eliminating non-required degrees of freedom. Certainly, the control method is well known in the art and will not be described herein.

In summary, the present invention has the advantages as follow:

1. The input device of the present invention has two suspending elements for suspending the movable hand-held shaft so that the input device of the present invention can be controlled easily by user. Therefore, it is more flexible than any one of the prior arts.

2. Although the movable hand-held shaft can only be moved in a limited space, the displayed object can be moved in a largest range according to the operation of the user via software calculations or mapping method.

3. The structure of the present invention is simpler than any one of the prior arts.

4. The input device of the present invention needn't to employ complex geometric calculations.

5. High resolution and sensitivity.

6. Low cost.

The input data can be used to control movement in any virtual reality environment such as flight simulators, virtual reality games, . . . etc. Such an input device can also be used to control mechanical devices, both real and simulated, such as robotic arms, wheelchairs, transport vehicles, mobile robots, . . . etc.

While the invention has been described in terms of what are presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. An input device for providing positional and attitude input data to one of a computer and an input driven device, comprising:
a movable hand-held shaft having two fulcrums thereon;
two suspending elements respectively connected to said two movable fulcrums of said movable hand-held shaft for providing a returning force to said movable hand-held shaft so as to return said movable hand-held shaft to an initial position;
two first position sensors respectively connected with said two suspending elements for detecting the translational displacement along X and Y axes of said movable hand-held shaft;
a second position sensor disposed in said movable hand-held shaft for detecting the translational and rotational displacement along Z axis of said movable hand-held shaft; and
a microprocessor for processing said translational and rotational displacement to obtain said positional and attitude input data to be sent to one of said computer and said input driven device.

2. The input device according to claim 1, wherein said positional and attitude input data is six degrees of freedom input data comprising 3-dimensional positional information and attitude information including pitch, yaw, and roll.

3. The input device according to claim 1, wherein said movable hand-held shaft further comprises at least one button for providing at least one control signal to one of said computer and said input driven device.

4. The input device according to claim 1, wherein each of said first position sensors is a planar position sensor comprising:
a first elastic belt;
a first set of fixed pulley for guiding said first elastic belt;
a first optical grating sensor having a first optical grating plate driven by said first elastic belt in response to the movement of said movable hand-held shaft for detecting said translational displacement of said movable hand-held shaft;
a second elastic belt;
a second set of fixed pulley for guiding said second elastic belt; and
a second optical grating sensor having a second optical grating plate driven by said second elastic belt in response to the movement of said movable hand-held shaft for detecting said translational displacement of said movable hand-held shaft,
wherein said first and said second elastic belts are connected to one suspending end of said movable hand-held shaft at an intersection thereof.

5. The input device according to claim 1, wherein said second position sensor comprises:
a third optical grating sensor having a third optical grating plate driven by a first gear of said movable hand-held shaft for detecting said translational displacement along Z axis of said movable hand-held shaft; and
a fourth optical grating sensor having a fourth optical grating plate driven by a second gear of said movable hand-held shaft for detecting said rotational displacement about Z-axis of said movable hand-held shaft.

6. The input device according to claim 1, wherein said suspending element is an elastic element capable of providing said returning force to said movable hand-held shaft.

7. The input device according to claim 1, wherein said elastic element is one selected from a group consisting of spring, rubber pad, and elastic belt.

8. The input device according to claim 1, further comprising a control device for controlling said input device to turn off some of said position sensors, thereby allowing said input device to provide two degrees of freedom input data.

9. The input device according to claim 1, wherein said movable hand-held shaft further comprises:
a main shaft covered by two separated cases;
a first gear mounted on the middle portion of said main shaft;
two first springs disposed around said main shaft at two sides of said first gear for providing a returning force along Z-axis to return the movable hand-held shaft to said initial position;
a second gear mounted on the lower portion of said main shaft;
a first projection disposed on one end of said main shaft; and
a second spring disposed around said main shaft and adjacent to said first projection;
wherein said second spring and said first projection cooperate with a second projection of said cases to provide a rotational returning force about Z-axis, thereby returning said movable hand-held shaft to said initial position.

10. The input device according to claim 1, wherein said microprocessor processes said translational and rotational displacement to obtain said positional and attitude input data via defined algorithm.

11. The input device according to claim 1, wherein said microprocessor processes said translational and rotational displacement to obtain said positional and attitude input data via mapping method.

12. An input device for providing positional and attitude input data to effect translational and rotational movements of a displayed object on a display, comprising:
a movable hand-held shaft having two movable fulcrums thereon;
two suspending elements respectively connected to said two fulcrums of said movable hand-held shaft for providing a returning force to said movable hand-held shaft so as to return said movable hand-held shaft to an initial position;
two first position sensors respectively connected with said two suspending elements for detecting the translational displacement along X and Y axes of said movable hand-held shaft;
a second position sensor disposed in said movable hand-held shaft for detecting the translational and rotational displacement along Z axis of said movable hand-held shaft; and
a microprocessor for processing said translational and rotational displacement to obtain said positional and attitude input data to effect translational and rotational movements of said displayed object on said display.

13. A planar position sensor for detecting a translational movement of an object, comprising:
a first elastic belt;
a first set of fixed pulley for guiding said first elastic belt;
a first optical grating sensor having a first optical grating plate driven by said first elastic belt in response to the movement of moving object for detecting the translational displacement of said object;
a second elastic belt;
a second set of fixed pulley for guiding said second elastic belt;
a second optical grating sensor having a second optical grating plate driven by said second elastic belt in response to the movement of said object for detecting said translational displacement of said object,
wherein said first and said second elastic belts are connected to one end of said object at an intersection thereof.
